(19) United States
(12) Patent Application Publication
(10) Pub. No.: US 2013/0068095 A1
(43) Pub. Date: Mar. 21, 2013

(54) PISTON HEAD WITH SEALING ARRANGEMENT

(71) Applicants: Bjorn A. Johansson, Uppsala (SE); Patrik Akerstrom, Uppsala (SE)

(72) Inventors: Bjorn A. Johansson, Uppsala (SE); Patrik Akerstrom, Uppsala (SE)

(73) Assignee: GE HEALTHCARE BIO-SCIENCES AB, UPPSALA (SE)

(21) Appl. No.: 13/699,750

(22) PCT Filed: May 24, 2011
(86) PCT No.: PCT/SE11/50642

§ 371 Date: Nov. 26, 2012

(30) Foreign Application Priority Data
May 26, 2010 (SE) 1050521-2

(51) Int. Cl. F16J 1/04; B29D 99/00

(52) U.S. Cl. CPC F16J 1/04; B29D 99/0053
USPC 92/208; 264/279

(57) ABSTRACT

A sanitary piston head with a body, said piston head having a fluid-contact end and a drive end and comprising a resilient sealing skirt arranged to provide sealing abutment against the inner wall of a cylinder when said piston head is inserted in said cylinder, wherein the resilient sealing skirt is biased in the sealing direction by a radially biasing element.

### TECHNICAL FIELD

The present invention relates generally to sealing arrangements for piston heads. More particularly the invention relates to sanitary piston heads for use with e.g. pharmaceuticals, foods and beverages.

### BACKGROUND OF THE INVENTION

Pistons are commonly used in displacement pumps, syringes etc for transport of liquids and pastes. In applications involving e.g. pharmaceuticals, foods and beverages it is essential that all fluid-contact components are designed to be sanitary, i.e. that they are easily cleaned, preferably without disassembling any components, and that there are no hidden or stagnant zones where microbial growth or biofilm formation may occur.

One area of concern for sanitary designs of pistons is the sealing between the piston head and the inner cylinder wall. The sealing must be efficient while giving a low degree of friction during movement of the piston and there should be no hidden crevices in the design. A common solution is to fit an O-ring or other elastomeric sealing element into a groove on the piston head, but this is not an ideal sanitary design due to the hidden crevices below the O-ring on the fluid-contact side of the piston. Further, most elastomer materials are prone to release leachables into the fluid which is undesirable, particularly in pharmaceutical applications.

Another solution, for plastic piston heads in e.g. glass or metal cylinders, is to have integral sealing flanges on the side of piston head. This solution does not give hidden crevices on the fluid-contact side but a very tight fit between the flange and the cylinder wall is necessary, giving rise to a very high friction and subsequent loss of sealing due to wear.

A third solution for plastic piston heads is to have an integral sealing skirt, as described in e.g. U.S. Pat. No. 6,427,517, extending backwards from the piston head. This gives a lower friction than a flange, but the creep deformation of plastics leads to a loss of sealing with time. There is thus a need for a sanitary design that gives both low friction and high sealing efficiency during long-term use.

### BRIEF DESCRIPTION OF THE INVENTION

One aspect of the present invention is to provide a piston head with good long-term sealing properties, low friction and a sanitary design. This is achieved with a piston head with a body, said piston head having a fluid-contact end and a drive end and comprising a resilient sealing skirt arranged to provide sealing abutment against the inner wall of a cylinder when said piston head is inserted in said cylinder, wherein the resilient sealing skirt is biased in the sealing direction by a radially biasing element. In other words, a resilient sealing skirt on the body of the piston head is energised by an elastically deformable element on the inside of said sealing skirt to provide a suitable sealing pressure.

### BRIEF DESCRIPTION OF THE DRAWINGS

FIG. 1 shows a piston with a piston head according to one embodiment of the invention.

FIG. 2 shows a piston with a piston head according to another embodiment of the invention.

FIG. 3 shows an enlargement of the sealing arrangement in FIG. 1.

FIG. 4 shows a piston with a piston head mounted on a hinge according to one embodiment of the invention.

FIG. 5 shows a piston head with a piston cap according to one embodiment of the invention.

FIG. 6 shows a piston head with a metal spring according to one embodiment of the invention.

### DEFINITIONS

The term fluid means herein any fluid transported, conveyed or dispensed by the piston of the invention. The fluid can be a gas, a liquid or a semi-solid.

The term fluid-contact end means herein the end of the piston head that is in contact with the fluid as defined above. The fluid contact is broken by the sealing line provided by the sealing arrangement, so the fluid-contact end only extends as far as the sealing line.

### DETAILED DESCRIPTION OF THE INVENTION

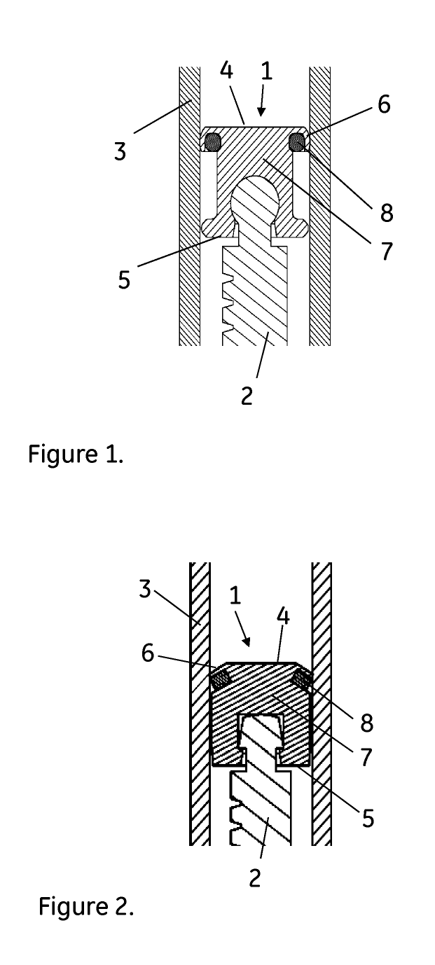

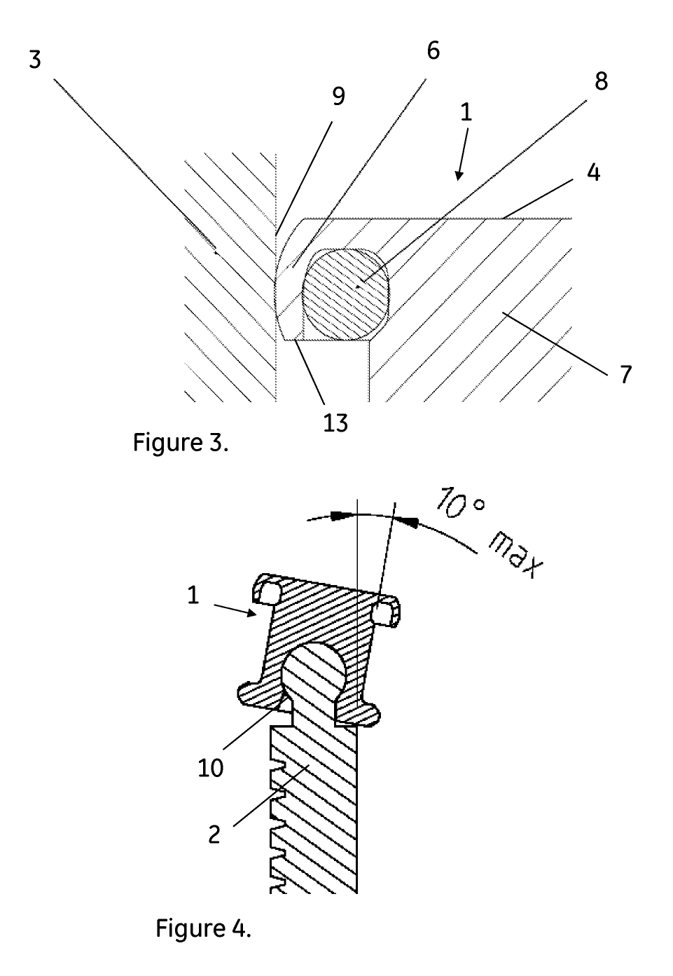

One embodiment of the invention, illustrated by FIGS. 1, 2 and 3, is a piston head 1 with a body 7, said piston head having a fluid-contact end 4 and a drive end 5 and comprising a resilient sealing skirt 6 arranged to provide sealing abutment against the inner wall 9 of a cylinder 3 when said piston head is inserted in said cylinder, wherein the resilient sealing skirt is biased in the sealing direction by a radially biasing element 8. The radially biasing element 8 applies a radial force to the sealing skirt 6, pressing it towards the cylinder wall 9 and thus providing a sealing force that is constant and predictable and suitable to give both good sealing and low friction during operation. In one embodiment the resilient sealing skirt 6 extends in the direction towards the drive end 5 of the piston head. This means that the radially biasing element 8 is behind the sealing line and not in contact with the fluid, which has the advantage that a sanitary design is provided. The end 13 of the sealing skirt 6 can form a free lip facing the drive end 5 of the piston head. This provides good sealing in combination with low friction and still provides a sanitary design, as the opening between the end 13 and the piston head is behind the sealing line.

In one embodiment the radially biasing element 8 is supported by the piston head body 7. An advantage of this is that the forces can be taken up by the body without appreciable deformation and that the radially biasing element can be kept in place by the body.

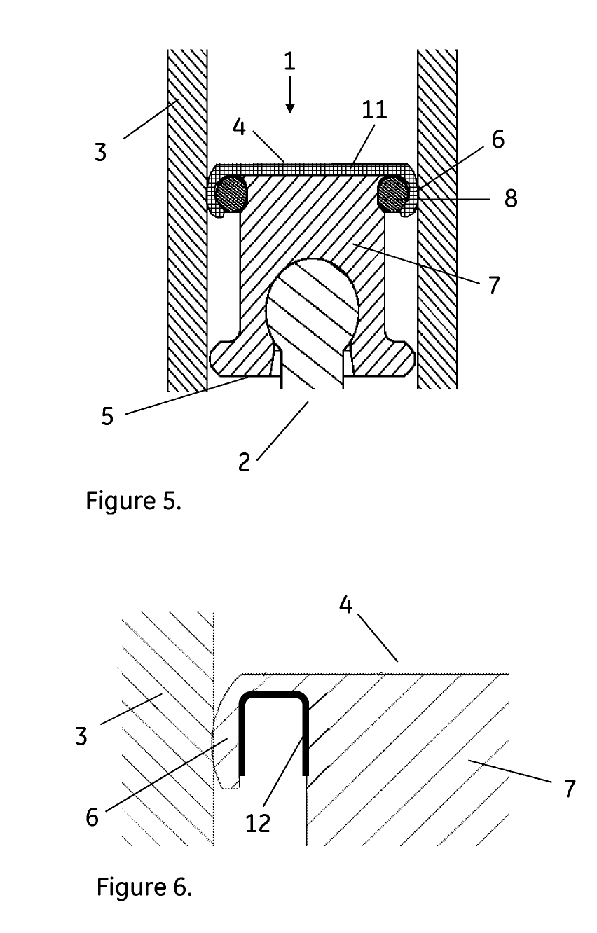

In one embodiment illustrated by FIG. 5 the resilient sealing skirt 6 is part of a piston cap 11. The piston cap 11 can be attached to the piston head body 7 in several ways, e.g. by snapping over the radially biasing element as indicated in FIG. 5, by a screw element, by a snapping arrangement in the center of the piston head body or by other means known in the art. An advantage of having the sealing skirt as an integral part of a piston cap is that a sanitary design can be achieved, with no crevices on the fluid-contact end of the piston head. Having a separate piston cap also offers the possibility of using a different material for the fluid-contact end than for the piston head body. The piston cap material can e.g. be a plastic giving particularly low friction, low wear, high flexibility and/or low amounts of leachables, while the piston head body material can be optimised with respect to strength, rigidity, low cost etc. Examples of piston cap materials include polyolefins such as polyethylene, e.g.

ultrahigh molecular weight polyethylene (UHMWPE) and fluoropolymers such as polytetrafluoroethylene (PTFE), fluorinated ethylene propylene (e.g. Teflon FEP from DuPont) or perfluoroalkoxy polymers (e.g. Teflon PFA from DuPont). Examples of materials for a separate piston head body include plastics (e.g. polypropylene, polyamides, polyoxymethylene, PEEK, polysulfone or polyethersulfone), metals and ceramics.

In one embodiment, illustrated by FIGS. 1, 2 and 3, the resilient sealing skirt 6 and the fluid-contact end 4 are integrally formed with the piston head body 7. An advantage of this is that a sanitary design can be achieved, with no crevices on the fluid-contact end. This design will also require a lower number of manufacturing operations, reducing cost. An integral piston head may be constructed from plastics like polyolefins (e.g. UHMWPE), fluoropolymers etc.

In one embodiment the radially biasing element 8 comprises an elastomer. Elastomers like EPDM, fluororubbers, silicone rubbers, thermoplastic elastomers etc have suitable elastic deformation properties to provide a radial bias giving appropriate sealing. They are also stretchable, facilitating the mounting of a ring over an integral piston head and they do not have any issues with corrosion in the salt solutions commonly used e.g. in processing of biopharmaceuticals. In a specific embodiment the radially biasing element 8 comprises an O-ring.

In one embodiment, illustrated by FIG. 6, the radially biasing element 8 comprises a metal spring 12. This spring can be ring-shaped and designed to provide a radial bias when compressed in the radial direction. Examples of metal springs can be rings with U- or V-shaped cross sections, helical coils, frusto-conical disks etc. The spring can optionally have a slit pattern to give specific mechanical properties. Stretchable metal springs can be mounted on integral and non-integral piston heads, while non-stretchable metal springs can be used e.g. with a piston cap design. Advantages of using a metal spring are that it can withstand high temperatures and harsh solvents.

In one embodiment the radially biasing element 8 is co-molded or insert molded with the piston head. Co-molding as described in the art may be used e.g. in cases where the piston head body comprises a thermoplastic and the radially biasing element comprises a thermoplastic elastomer. It has the advantage that the entire piston head can be manufactured in one operation and it allows for designs that can not conveniently be assembled from separate parts. Insert molding is known in the art and may e.g. be used with metal springs. It simplifies manufacturing and may e.g. be used to introduce a non-stretchable metal spring in an integral piston head. In one embodiment the piston head 1 is manufactured by a method comprising a step of co-molding or insert molding.

In one embodiment the piston head 1 comprises only one sealing arrangement such as a resilient sealing skirt 6 biased in the sealing direction by a radially biasing element 8. The advantage of this is that the friction against the cylinder wall will be reduced, particularly as any second sealing arrangement will not be in contact with the fluid and hence will not be lubricated by the fluid.

In one embodiment the piston head 1 is attached to a piston rod 2. In a specific embodiment illustrated in FIG. 4 the drive end 5 of the piston head 1 is attached to a piston rod 2 via a hinge 10 allowing up to 10 degrees deflection of the piston head. This has the advantage that any misalignment in the driving unit is not transferred to the piston head and leakage and/or jamming of the piston head is prevented. This is particularly important for a piston head with a single sealing arrangement where there is no alignment provided by a second sealing arrangement.

Other features and advantages of the invention will be apparent from the following examples and from the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

All patents, patent publications, and other published references mentioned herein are hereby incorporated by reference in their entireties as if each had been individually and specifically incorporated by reference herein. While preferred illustrative embodiments of the present invention are described, one skilled in the art will appreciate that the present invention can be practiced by other than the described embodiments, which are presented for purposes of illustration only and not by way of limitation. The present invention is limited only by the claims that follow.

1. A piston head (1) with a body (7), said piston head having a fluid-contact end (4) and a drive end (5) and comprising a resilient sealing skirt (6) arranged to provide sealing abutment against the inner wall (9) of a cylinder (3) when said piston head is inserted in said cylinder, wherein the resilient sealing skirt is biased in the sealing direction by a radially biasing element (8).

2. The piston head of claim 1, wherein the resilient sealing skirt extends in the direction towards the drive end.

3. The piston head of claim 1, wherein the radially biasing element is supported by the piston head body.

4. The piston head of claim 1, wherein the resilient sealing skirt is part of a piston cap (11).

5. The piston head of claim 1, wherein the resilient sealing skirt and the fluid-contact end are integrally formed with the body.

6. The piston head of claim 1, wherein the radially biasing element comprises an elastomer.

7. The piston head of claim 1, wherein the radially biasing element comprises an O-ring.

8. The piston head of claim 1, wherein the radially biasing element comprises a metal spring.

9. The piston head of claim 1, wherein the radially biasing element is co-molded or insert molded with the piston head.

10. The piston head of claim 1, wherein the piston head is attached to a piston rod (2).

11. The piston head of claim 10, wherein the drive end of the piston head is attached to a piston rod via a hinge (10) allowing up to 10 degrees deflection of the piston head.

12. A method of manufacturing the piston head of claim 1, further comprising a step of co-molding or insert molding.
